(19) United States
(12) Patent Application Publication
(10) Pub. No.: US 2025/0353426 A1
(43) Pub. Date: Nov. 20, 2025

(54) APPARATUS FOR USE IN LOADING SHIPPING CONTAINERS

(71) Applicant: JAXAL INDUSTRIES PTY LTD, Kalgoorlie (AU)

(72) Inventors: Paul MCKENZIE, Kalgoorlie (AU); Luke CRAKER, Kalgoorlie (AU); Jon Louie CAMINERO, Kalgoorlie (AU)

(21) Appl. No.: 18/870,977

(22) PCT Filed: Jun. 2, 2023
(86) PCT No.: PCT/AU2023/050482

§ 371 Date: Dec. 2, 2024

(30) Foreign Application Priority Data
Jun. 3, 2022 (AU) 2022901537

(51) Int. Cl. B60P 7/13; F16B 21/02

(52) U.S. Cl. CPC B60P 7/132; F16B 21/02

(57) ABSTRACT

A connector (10) for use in loading a container (100) onto a vehicle having a flat-bed tray (40). The container (10) has a connection point (102) at a lower corner thereof. The connector (10) includes a body (12) and a releasable attachment portion (14). The releasable attachment portion (14) is configured to enable the connector (10) to be releasably attached to the connection point (102). The connector (10) is releasably attachable at only one lower corner of the container (100) at a time.

### TECHNICAL FIELD

The present invention relates to an apparatus for use in loading shipping containers, such as onto a tilt-tray or tilt-bed truck.

### BACKGROUND

Cargo or sea containers (shipping containers) are commonly used for transporting goods by land on trucks, by rail on railway rolling stock or by sea on container ships.

Shipping containers are generally constructed with sufficient strength to withstand handling, shipment, inter-modal transhipment and storage (often stacked for transport or storage one on top of another). Shipping containers are typically large reusable steel boxes used for intermodal shipments. In the context of international shipping trade, “container” or “shipping container” is virtually synonymous with “intermodal freight container”, that is, a container designed to be moved from one mode of transport to another without unloading and reloading the contents of the container.

Such shipping containers are generally of a rectangular parallelepiped configuration to enable the containers to be stacked one on top of the other or to enable the containers to be supported on a deck of a ship or on a tray of a transport vehicle such as a railcar or road vehicle.

Shipping containers are usually provided in standard 20 ft (about 6.096 m) or 40 ft (about 12.19 m) lengths, with doors on at least one end to provide access to the interior of the container. Standard sized containers are typically 8 ft (about 2.438 m) in width and 8 ft 6 inches (about 2.591 m) high, though a ‘high cube’ is 9 ft 6 inches (about 2.896 m) high.

Corner fittings or sockets are provided at each external corner of the container for engagement by connecting devices to secure the container to the deck of a ship or tray of a vehicle or to secure containers together. The corner fittings include apertures on the lower sides and corners of the container for receipt of rotatable cleats or lugs of the connecting devices which are receivable within the apertures and which are rotatable to lock the containers in position. Apertures are also provided at the top, side and end faces of the container so that containers stacked upon each other can be locked together or adjacent containers locked together by similar connecting devices in an end-to-end or side-by-side configuration.

Particular difficulty occurs when a shipping container at ground level is to be loaded onto a flat bed or tray of a road vehicle, but no crane, container handler or hoist is available to lift the container onto the tray. With this type of vehicle, the bed or tray (often configured to be slidably mounted on the vehicle chassis) is tilted to an inclined position and moved into longitudinal alignment with and adjacent to, an end of the container. A winch cable of a winch mounted centrally at a front end of the tilt-tray is coupled to the container for the container to be winched onto the tray.

It is not uncommon for the end of the container to abut the rear end of the tray and to become jammed against the rear end of the tray, thereby preventing the container from being winched onto the tray of the vehicle. The result is that a substantial load is then placed on the winch producing high tension in the cable, with the potential for catastrophic failure of either the winch or the cable. If the cable should break it may result in severe injury and even death for any person in the vicinity who may be struck by the cable.

Australian Patent No 2006200964 discloses an elongate solid drawbar to connect to the transversely spaced corners at one end of the container. A winch cable is attached centrally to the drawbar, and the winch, cable and drawbar draw the container onto the flat-bed tray.

A similar elongate solid drawbar is disclosed in Australian Patent No. 2012231771, which patent focuses on the problem associated with the reverse process of unloading a container from a flat-bed tray. When the container is ready to be unloaded from the flat-bed tray, gravitational forces acting on the container by tilting the tray may not be sufficient to overcome the frictional forces between the bottom of the container and the tray. There is also a risk that the container may slide backwards off the tray in an uncontrolled manner. Australian Patent No. 2012231771 further discloses a vehicle mounted ejector for assisting in unloading the shipping container from the flat-bed tray.

It has been realised that a solid drawbar can be difficult to attach to the lower end corners of the container. The container, being very heavy, can settle into soft ground, or the container may have been deposited on the ground with some force thereby causing the end of the container to dig into the ground, or the ground can be uneven at the end of the container. Naturally, a solid drawbar, whilst providing a fixed central attachment point for a winch, can be difficult to connect to the container because of its fixed length and the fixed spacing of the connection points at each end, in combination with the solid structure of the drawbar.

Also, such a drawbar is sufficiently heavy to safely need at least two people to manhandle it into position on the ground at the foot of the container, thereby risking injury to the operators, or at least requiring more than one person and the extra cost associated therewith.

Furthermore, a solid drawbar needs to be stored safely on the vehicle when travelling to site to load the container. Such a drawbar is typically stored on the flat-bed tray because of its length, thereby taking up space on the flat-bed tray where such space might be needed for a load.

References to prior art in this specification are provided for illustrative purposes only and are not to be taken as an admission that such prior art is part of the common general knowledge in Australia or elsewhere.

The present invention seeks to ameliorate one or more of the aforementioned problems or at least provide an alternative thereto.

### SUMMARY

According to some embodiments, there is provided a connector for use in loading a container onto a vehicle having a flat-bed tray. The container may have a connection point at a lower corner thereof. The connector may include a body and a releasable attachment portion, the releasable attachment portion being configured to enable the connector to be releasably attached to the connection point. The connector may be releasably attachable at only one lower corner of the container at a time.

According to some embodiments, the body comprises the releasable attachment portion.

According to some embodiments, the releasable attachment portion includes a protrusion that is configured to enable the connector to releasably attach to the connection point.

According to some embodiments, the releasable attachment portion comprises an elongate portion.

According to some embodiments, the protrusion is operably connected to the elongate portion.

According to some embodiments, the protrusion is longer in a major direction than in a minor direction.

According to some embodiments, the body defines a channel such that when the protrusion is inserted into an aperture of the connection point of the container, the protrusion is rotatable within the connection point such that a wall portion of the connection point resides in the channel.

According to some embodiments, the channel is defined between the protrusion and a portion of the body of the connector.

According to some embodiments, the connector further includes a locking device.

According to some embodiments, the locking device is moveable relative to the body.

According to some embodiments, the locking device includes a slide lock member or slide bolt.

According to some embodiments, the locking device includes a forward end portion that is configured to at least partially enter and retain the protrusion in the connection point until the locking device is released.

According to some embodiments, the locking device includes a tab, flange, cam or lobe that is configured to be inserted into a portion of the aperture of the connection point.

According to some embodiments, the forward end portion comprises the tab, flange, cam or lobe.

According to some embodiments, the locking device comprises a shaft portion that is configured to be connected to the forward end portion.

According to some embodiments, the locking device comprises a biasing member that is configured to bias the locking device in a locked position.

According to some embodiments, the body of the connector comprises a locking device retaining portion.

According to some embodiments, the locking device retaining portion defines a hole.

According to some embodiments, the locking device extends through the hole.

According to some embodiments, the locking device retaining portion comprises a groove. According to some embodiments, the locking device comprises an intermediate projection. According to some embodiments, the groove is configured to receive the intermediate projection such that relative rotation between the body and the locking device is inhibited.

According to some embodiments, the shaft portion comprises the intermediate projection.

According to some embodiments, the tab, flange, cam or lobe of the locking device is configured to rotate within the connection point to lock the locking device until counter rotated to a release position.

According to some embodiments, the locking device comprises a first shaft portion. According to some embodiments, the locking device comprises a second shaft portion. According to some embodiments, the first shaft portion is connected to, and extends away from, the forward end portion. According to some embodiments, the second shaft portion is connected to, and extends away from, the forward end portion.

According to some embodiments, the forward end portion bridges the first shaft portion and the second shaft portion.

According to some embodiments, the first shaft portion and the second shaft portion are parallel.

According to some embodiments, the body of the connector comprises a locking device retaining portion.

According to some embodiments, the locking device retaining portion comprises a first hole. According to some embodiments, the locking device retaining portion comprises a second hole. According to some embodiments, the first shaft portion extends through the first hole. According to some embodiments, the second shaft portion extends through the second hole.

According to some embodiments, the elongate portion, the first hole, the second hole, the first shaft portion and the second shaft portion are parallel.

According to some embodiments, the body comprises a first groove that is configured to receive the first shaft portion. According to some embodiments, the body comprises a second groove that is configured to receive the second shaft portion.

According to some embodiments, the locking device includes a handle portion.

According to some embodiments, the handle portion is configured to be connected to the shaft portion.

According to some embodiments, the handle portion extends between the first shaft portion and the second shaft portion.

According to some embodiments, the handle portion is disposed at an opposite end of each of the first shaft portion and the second shaft portion as the forward end portion.

According to some embodiments, when the protrusion is received into an elongate aperture of the connection point, rotation of the protrusion leaves an open portion of the aperture, and the locking device is configured to at least partially fill the open portion to restrict or prevent removal of the protrusion until the locking device is removed from the aperture.

According to some embodiments, the connector may further include a body attachment portion, the body attachment portion being configured to enable an elongate member to be connected to the connector. The elongate member may be a cable or chain.

According to some embodiments, the attachment portion includes a loop or eye attached to or forming part of the body.

According to some embodiments, the body comprises a retainer, the body attachment portion being configured to connect to the retainer.

According to some embodiments, the retainer is integrally formed with the body.

According to some embodiments, the retainer comprises a hole in the body.

According to some embodiments, the hole extends between the first shaft portion and the second shaft portion.

According to some embodiments, the attachment portion may be attached to the body via a pivot allowing the attachment portion to pivot towards the body for stowage and extend outward when in use drawing the container.

According to some embodiments, one or more of the body and the releasable attachment portion may be made of steel.

According to some embodiments, the body may be made by one-piece casting, forging or fabrication and/or the releasable attachment portion may be made by one-piece casting, forging or fabrication.

According to some embodiments, the protrusion defines a first connection point contacting face, the first connection point contacting face being configured to contact an internal surface of the connection point.

According to some embodiments, the connector further comprises an external engagement portion, the external engagement portion being configured to engage an external surface of the connection point.

According to some embodiments, the external engagement portion defines a second connection point contacting face, the second connection point contacting face being configured to contact an external surface of the connection point.

According to some embodiments, an area of the second connection point contacting face is greater than an area of the first connection point contacting face.

According to some embodiments, the external engagement portion at least partially surrounds the forward end portion of the locking device.

According to some embodiments, the channel is defined between the protrusion and the external engagement portion.

According to some embodiments, the connector further comprises an axial stop that is configured to inhibit movement of the locking device in an axial direction.

According to some embodiments, the axial stop is removably connected to a part of the body.

According to some embodiments, the axial stop is integrally formed with the body.

According to some embodiments, the axial stop is on an opposing side of the body to the protrusion.

According to some embodiments, an apparatus may include the connector as outlined, a second connector configured to connect to the container, and a flexible elongate member configured to connect the connector and the second connector.

According to some embodiments, the flexible elongate member may include a cable or chain, or a cable and chain combination.

According to some embodiments, the flexible elongate member may be attachable directly or indirectly to a winch for drawing the container onto a flat-bed tray of a vehicle by force applied to the flexible elongate member and the connectors.

According to some embodiments, the connector and the second connector may each be handed, such that the connector includes part of the releasable attachment mechanism that rotates in a first direction to connect the connector to the container, and the second connector includes part of a further said releasable connection mechanism that rotates in a second direction opposite to the first direction.

According to some embodiments, there is provided a method of loading a container onto a truck flat-bed or tray. The method may include the steps of: attaching the connector of the apparatus previously described to a first connection point at a respective lower corner of an end of a shipping container; attaching the second connector of the apparatus previously described to a second connection point at another lower corner of the end of the shipping container; providing the flexible elongate member to the connector and the second connector such that the connector and the second connector are connected; providing a winch cable connected between a winch of the vehicle and the flexible elongate member; inclining the flat-bed or tray at an angle such that a lower edge of the flat-bed or tray engages under the connector and the second connector and/or a lower end edge of the container; and drawing the container onto the flat-bed or tray by use of the winch.

According to some embodiments, the inclination of the flat-bed or tray may be reduced towards horizontal when the container is at least partly loaded onto the flat-bed or tray.

According to some embodiments, one or more of the connector and the second connector are rotated for connection to the container.

According to some embodiments, the second connector may be rotated in a different direction to the direction of the rotation of the connector for releasable engagement with the container.

According to some embodiments, a locking device of the connector may include a portion configured to be inserted into the respective connection device to inhibit reverse rotation of the connector until the locking device is released.

According to some embodiments, the connector, the second connector and the elongate member may be provided as a kit of components.

### BRIEF DESCRIPTION OF THE DRAWINGS

One or more embodiments of the present disclosure will hereinafter be described with reference to the accompanying Figures, in which:

FIGS. 1A to 1E show perspective views of a connector, configured to be at least partially inserted into an aperture of a container so as to assist with loading the container onto a vehicle, according to some embodiments;

FIG. 2 shows a front perspective view of the connector of FIG. 1 with a locking device retracted, according to some embodiments;

FIG. 3 shows a front perspective view of the connector of FIG. 1 with a locking device extended, according to some embodiments;

FIG. 4 shows a top view of an apparatus comprising two of the connectors of FIG. 1, according to some embodiments, each connector being connected to a respective corner of a shipping container, with an elongate member such as a chain connected to each connector;

FIG. 5 shows a perspective view of the apparatus of FIG. 4, according to some embodiments;

FIG. 6 shows a side view of a shipping container connected to the apparatus of FIG. 4, according to some embodiments, the apparatus being used to load the shipping container onto a truck tray;

FIG. 7 shows a side perspective view of another embodiment of the connector, with a locking device retracted and latched, according to some embodiments;

FIG. 8 shows a perspective view of the connector of FIG. 7, according to some embodiments;

FIG. 9 shows a perspective view of the connector of FIG. 7, with the locking device unlatched, extended and in a lock position, according to some embodiments;

FIG. 10 shows a perspective view of a number of connectors in an alternative configuration, the connectors being connected with an elongate member, according to some embodiments;

FIG. 11 shows a perspective view of another connector, according to some embodiments;

FIG. 12 shows another perspective view of the connector of FIG. 11, according to some embodiments;

FIG. 13 shows another perspective view of the connector of FIG. 11, according to some embodiments;

FIG. 14 shows a side view of the connector of FIG. 11, according to some embodiments;

FIG. 15 shows a perspective view of a body of a connector, according to some embodiments;

FIG. 16 shows a perspective view of a body of a connector, according to some embodiments;

FIG. 17 shows a perspective view of a body of a connector, according to some embodiments;

FIG. 18 shows a perspective view of another connector, according to some embodiments;

FIG. 19 shows a side view of the connector of FIG. 18, according to some embodiments;

FIG. 20 shows another perspective view of the connector of FIG. 18, according to some embodiments;

FIG. 21 shows a perspective view of another connector, according to some embodiments; and

FIG. 22 shows another perspective view of the connector of FIG. 21, according to some embodiments.

### DETAILED DESCRIPTION

It is to be appreciated that each of the embodiments is specifically described and that the present invention is not to be construed as being limited to any specific feature or element of any one of the embodiments. Neither is the present invention to be construed as being limited to any feature of a number of the embodiments or variations described in relation to the embodiments.

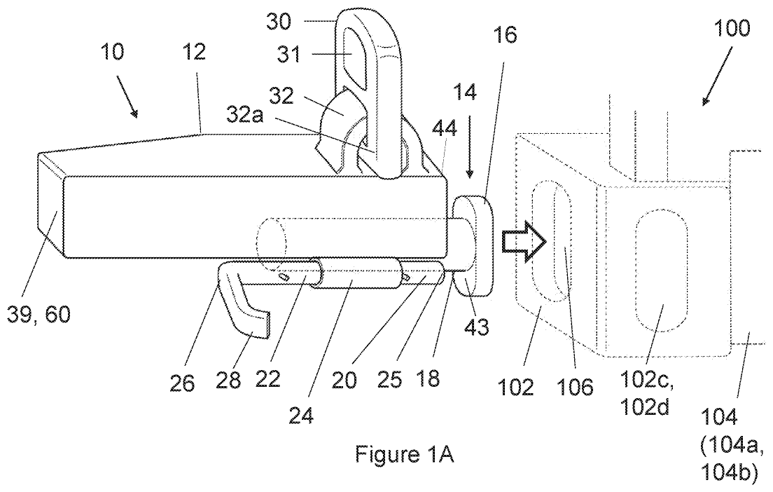

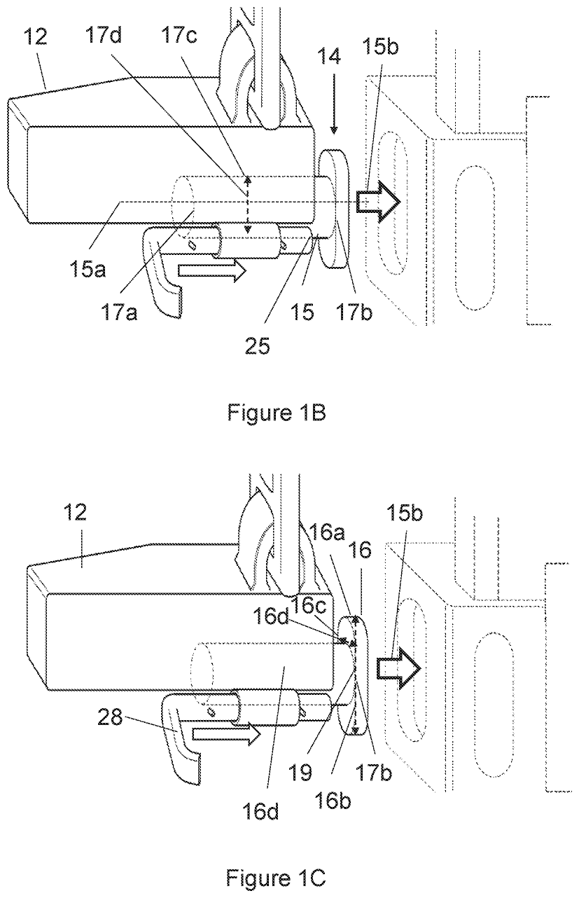

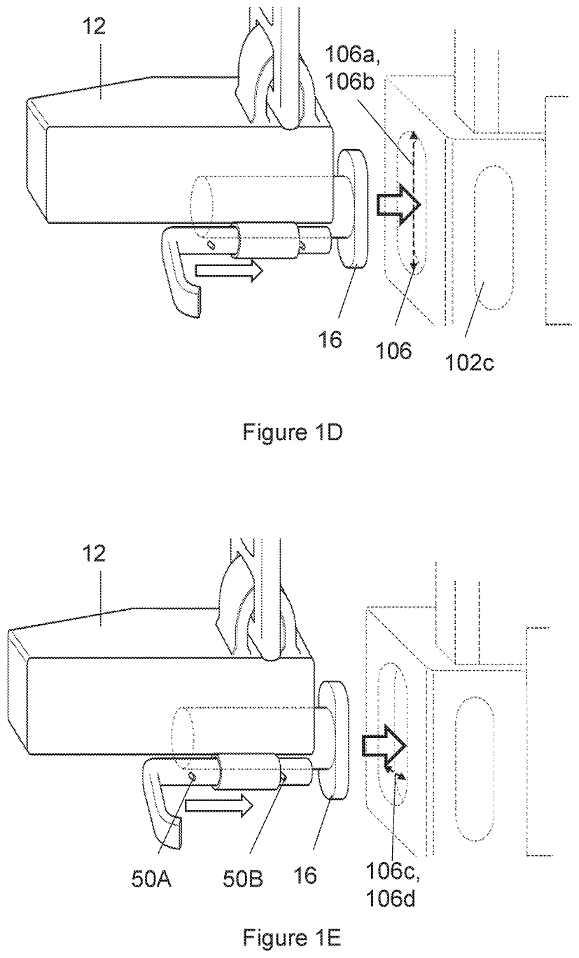

FIGS. 1A to 1E show a number of views of a connector 10. The connector 10 is for use in moving a container 100. For example, the connector 10 may be for use in moving a container 100 onto or from a vehicle having a flat-bed tray 40. The container 100 has connection points 102a, 102b. The connection points 102a, 102b may be at lower corners 104a, 104b thereof. Specifically, the container 100 has a first connection point 102a at a first lower corner 104a. The container 100 also has a second connection point 102b at a second lower corner 104b.

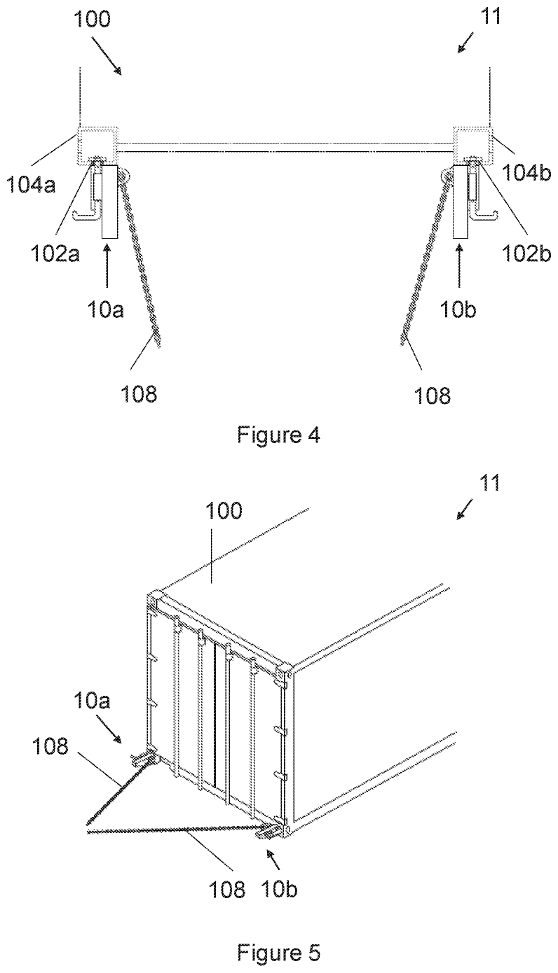

FIGS. 4 and 5 show an apparatus 11. The apparatus 11 may be referred to as a container moving system 11 and/or a system 11 for moving a container. The apparatus 11 includes the connector 10. In particular, the apparatus 11 includes two connectors 10a, 10b. Connector 10a may be in the form of the connector 10. Connector 10b may be in the form of connector 10. In use, one connector 10 is releasably attached to each of the respective connection points 102a, 102b of the lower corners 104a, 104b of the container 100. That is, each connector 10a, 10b is releasably attached at only one lower corner 104a, 104b of the container 100.

The connector 10 includes a body 12. The connector 10 includes a releasable attachment portion 14. The releasable attachment portion 14 may be referred to as a releasable attachment mechanism. The releasable attachment portion 14 is configured to releasably attach the respective connector 10 to a respective connection point 102. In other words, the releasable attachment portion 14 is configured to enable the connector 10 to be releasably attached to a connection point 102. The releasable attachment portion 14 is connected to the body 12. In some embodiments, the releasable attachment portion 14 is integrally formed with the body 12. The body 12 may be said to comprise the releasable attachment portion 14.

The releasable attachment portion 14 comprises an elongate 15. The elongate portion 15 may be referred to as a shaft 15. The shaft 15 extends radially outward from a longitudinal axis 15a. The shaft 15 extends in a longitudinal direction 15b from a first shaft end 17a to a second shaft end 17b. The longitudinal direction 15b is parallel to the longitudinal axis 15a. In other words, the shaft 15 extends along a longitudinal axis, 15a. The shaft 15 defines a shaft outer dimension 17c. The shaft outer dimension 17c is an outer dimension of the shaft measured in a radial direction 17d of the shaft 15. The shaft 15 is connected to the body 12. The shaft 15 may be directly connected to the body 12 (e.g. by way of a welded connection between the body 12 and the shaft 15). The shaft 15 may be considered part of the body 12.

The releasable attachment portion 14 includes a protrusion 16. In some embodiments, the protrusion 16 may be referred to as a connection point engaging portion. The protrusion 16 is disposed at an end of the shaft 15. In particular, the protrusion 16 is disposed at the second shaft end 17b. The protrusion 16 extends outwardly from a central portion 19. In some embodiments, the protrusion 16 extends outwardly in the radial direction from the central portion 19. In some embodiments, the shaft 15 (i.e. the elongate portion 15) may be considered part of the protrusion 16. That is, the protrusion 16 may be said to comprise the shaft 15 (i.e. the elongate portion 15). The protrusion 16 is operably connected to the elongate portion 15. The protrusion 16 is configured to enable the connector 10 to releasably attach to the connection point 102.

As shown in FIG. 1B, the protrusion 16 defines a first outer dimension 16a. The first outer dimension 16a is a dimension of the protrusion 16 when measured in a first direction 16b. The first direction 16b is orthogonal to the longitudinal direction 15b of the shaft. The protrusion 16 defines a second outer dimension 16c. The second outer dimension 16c is a dimension of the protrusion 16 when measured in a second direction 16d. The second direction 16d is orthogonal to the longitudinal direction 15b of the shaft. The second direction 16d is orthogonal to the first direction 16b. The first outer dimension 16a is greater than the second outer dimension 16c. In other words, the protrusion 16 is longer in a major direction (the first direction 16b) than a minor direction (the second direction 16d). The first outer dimension 16a is greater than the shaft outer dimension 17c. In particular, the first outer dimension 16a is greater than a maximum outer dimension of the shaft 17c. That is, the protrusion 16 extends radially outwards past the shaft outer surface. In some embodiments, the second outer dimension 16c is also greater than the shaft outer dimension 17c.

The protrusion 16 is configured to releasably engage with the respective connection point 102.

The connector 10 comprises a channel 18. The channel 18 is provided between the body 12 of the connector 10, and the protrusion 16 of the releasable attachment portion 14. In other words, the body 12 defines the channel 18. The channel 18 is defined between the protrusion 16 and a portion of the body 12.

The connection point 102 comprises an aperture 106. The aperture 106 extends from an outer surface portion of the connection point 102 to an inner surface portion of the connection point 102. The aperture 106 defines a channel through a wall of the connection point 102 to a hollow inner volume of the connection point 102.

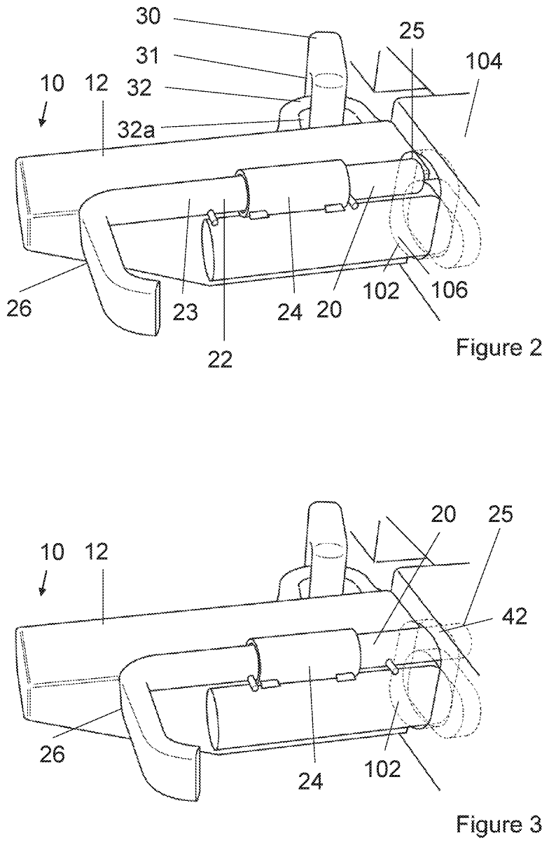

As shown in FIGS. 1D and 1E, the aperture 106 is sized to enable the protrusion 16 to pass through the aperture 106 when the protrusion 16 is in a first pose (relative to the connection point 102). The aperture 106 is sized to inhibit movement of the protrusion 16 through the aperture 106 when the protrusion is in a second pose (relative to the connection point 102) as shown in FIGS. 2 and 3. Specifically, the aperture 106 defines a first aperture dimension 106a. The first aperture dimension 106a is a dimension of the aperture 106 when measured in a first aperture measurement direction 106b. The first aperture measurement direction 106b may correspond to the first direction that the protrusion 16 may be measured in.

In particular, the first aperture measurement direction 106b may correspond to the first direction when the protrusion 16 is in the first pose. The aperture 106 defines a second aperture dimension 106c. The second aperture dimension 106c is a dimension of the aperture 106 when measured in a second aperture measurement direction 106d. The second aperture measurement direction 106d may correspond to the second direction that the protrusion 16 may be measured in. In particular, the second aperture measurement direction 106d may correspond to the second direction when the protrusion 16 is in the first pose. The second aperture measurement direction 106d is orthogonal to the first aperture measurement direction 106b.

The first aperture dimension 106a is greater than the first outer dimension of the protrusion 16. The second aperture dimension 106c is greater than the second outer dimension 16c of the protrusion 16. In certain orientations, such as that shown in FIG. 1 (i.e. the first pose relative to the connection point 102), the protrusion 16 is configured to be inserted through the aperture 106.

As shown in FIG. 1, the protrusion 16 can be inserted into the aperture 106 of the relevant connection point 102 of the container 100. The protrusion 16 may therefore be received by the hollow internal volume 102c of the connection point 102. After insertion, the protrusion 16 of the connector 10 can be moved (either of a translation or a rotation), relative to the connection point 102, such that a wall portion 42 of the connection point 102 resides in the channel 18. FIGS. 2 and 3 show the connector 10 positioned such that the wall portion 42 of the connection point 102 resides in the channel 18 (i.e. the protrusion 16 is in the second pose). The protrusion 16 (and the body 12) may be said to be in an initial state prior to the rotation. The protrusion 16 (and the body 12) may be said to be in an engaged state after the rotation. FIGS. 2 and 3 show the protrusion 16 in the engaged state. When in the engaged state, the protrusion 16 contacts an inner surface 102d of the connection point 102 when one attempts to move the protrusion 16 out through the aperture 106 and away from the connection point 102.

Preferably the body 12 and the protrusion 16 rotate together. In other words, rotation of the body 12 may cause a corresponding rotation of the protrusion 16. However, it will be appreciated that the protrusion 16 may be arranged to rotate relative to the body 12.

The connector 10 comprises a locking device 20. The locking device 20 is configured to retain the protrusion 16 in the connection point 102. In particular, the locking device 20 is configured to retain the protrusion 16 in the connection point 102 when the protrusion 16 is in the engaged position. The locking device 20 is configured to at least partially enter and retain the protrusion 16 in the connection point 102 until the locking device 20 is released.

The locking device 20 is moveable relative to the body 12. The locking device 20 is configured to selectively retain the protrusion 16 in the connection point 102. For example, once the protrusion 16 is rotated to engage in the aperture 106 to retain the connector 10 to the container 100, the locking device 20 can be actuated to prevent the protrusion 16 (and therefore the connector 10) from releasing from the container 100 until the locking device 20 is released and the protrusion 16 can be rotated back again for release of the connector 10 from the container 100.

The connector 10 comprises a locking device retaining portion 24. The locking device retaining portion 24 is configured to facilitate movement of the locking device 20. The locking device retaining portion defines a hole. The locking device 20 extends through the hole.

The locking device 20 can include a shaft portion 22. The shaft portion 22 may be referred to as a shaft. The shaft portion 22 is circular and elongate. The shaft portion 22 is arranged to slide within a keeper 24. The locking device 20 can include a slide lock member or slide bolt 23 (shown in FIGS. 1-3), and/or a lobe (shown in FIGS. 7-9) configured to be inserted into a portion of the aperture 106 of the connection point 102.

The locking device 20 comprises a forward end portion 25. The forward end portion 25 may be referred to as a forward end 25. The forward end portion 25 is configured to be received within the aperture 106 of the connection point 102 to prevent release of the protrusion 16. The forward end portion 25 is configured to be connected to the shaft portion 22. Similarly, the shaft portion 22 is configured to be connected to the forward end portion 25.

The locking device 20 includes a tab, flange, cam or lobe 29. In the illustrated embodiment, the locking device 20 comprises a lobe 29. In particular, the forward end portion 25 comprises or is in the form of the lobe 29. The lobe 29 (in FIGS. 7-9) of the locking device 20 is configured to rotate within the connection point 102 to lock the locking device 20 in position until counter rotated to a release position.

A trailing end 26 of the locking device 20 can include a handle portion 28. In the illustrated embodiment the handle portion 28 is integrally formed with the shaft portion 22. In some embodiments, the handle portion 28 is configured to be connected to the shaft portion 22. The handle portion 28 is disposed at an opposite end of the shaft portion 22 to the forward end portion 25.

As shown in FIGS. 1A-1E, 2 and 3, in this embodiment, the handle portion 28 of the locking device 20 is moved forward by a pushing movement to move the locking device 20 forwards towards the protrusion 16. In particular, a forward end 25 of the locking device 20 is moved towards the protrusion 16. The forward end 25 of the locking device 20 may be in the form of a rod so that the forward end 25 is rounded, as shown in FIGS. 1A-1E, 2 and 3.

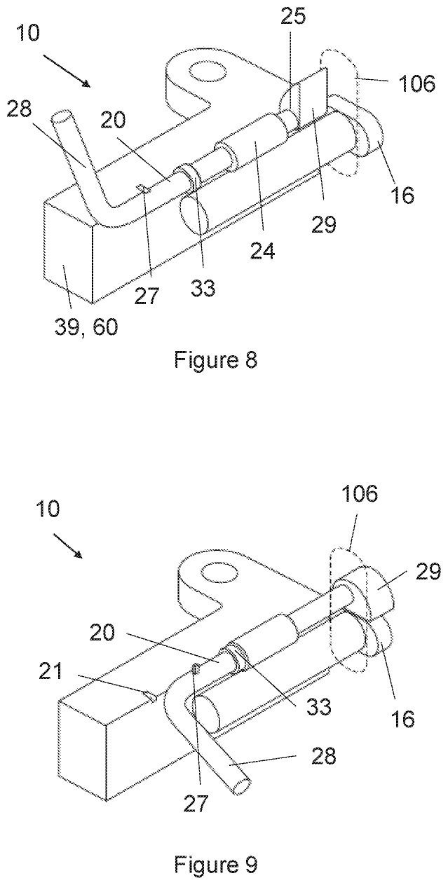

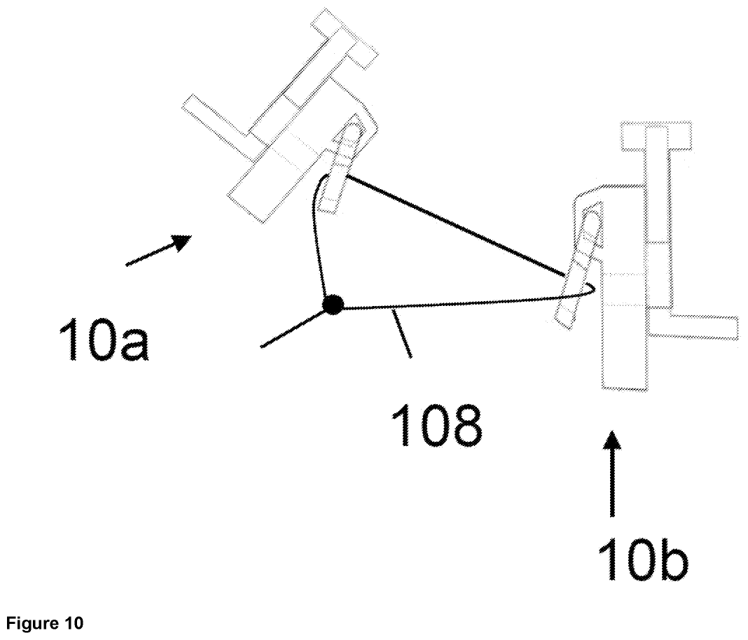

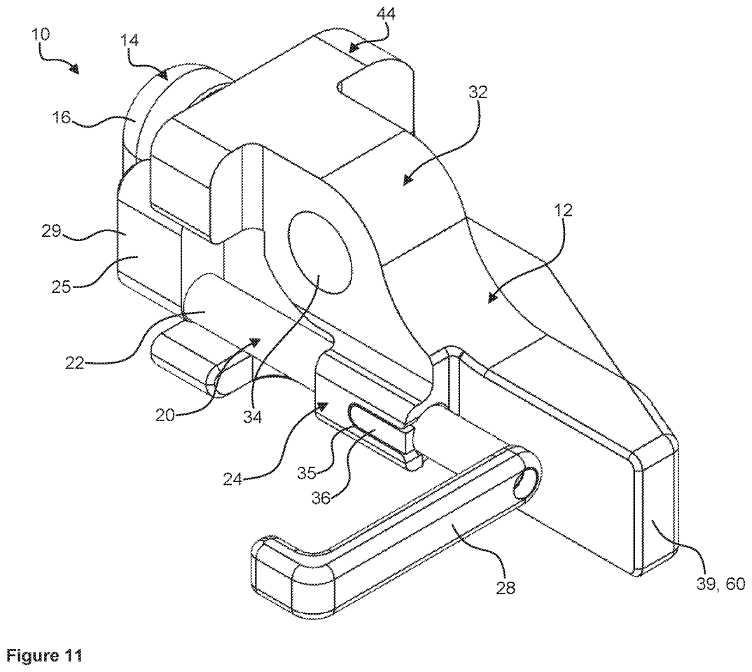

In another embodiment, as shown in FIGS. 7-9, the forward end 25 of the locking device 20 comprises a lobe 29. The lobe 29 may be attached to the shaft portion 22. The lobe 29 and the shaft portion 22 of the locking device 20 may be integrally formed. The lobe 29 is flat on one side as shown in FIGS. 7 and 8. As shown in FIG. 9, the lobe is curved on a side opposite to the flat side so that the curved side and the flat side meet at an apex. The lobe 29 may therefore be said to form a tear drop shape. The attachment of the lobe 29 to the forward end 25 of the locking device 20 is such that when the handle portion 28 of the connector 10 is rotated, the lobe 29 correspondingly rotates in the same direction as the handle portion 28. The keeper 24 remains stationary, whilst the locking device 20 is pushed through the hollow keeper 24. The locking device 20 may also have a stop 33 which abuts onto the keeper 24 as the locking device 20 is pushed through the keeper 24, stopping the locking device 20 from moving further forward if further forward pushing is applied to the handle portion 28, as shown in FIG. 9.

As shown in FIG. 9, in use, once the lobe 29 is pushed forward towards the protrusion 16 (not shown is the protrusion 16 being rotated once inside the aperture 106 by rotating the body 12), the lobe 29 moves forward into the aperture 106 and is rotated so that the flat side of the lobe 29 lies against the flat side of the protrusion 16, using the handle portion 28. This inhibits movement of the lobe 29 to reduce the likelihood of the lobe 29 falling back out of the aperture 106. This enables the lobe 29 to hold the entire apparatus 11 in place.

In the embodiment of FIGS. 1A to 3, the locking device comprises a pair of projecting features 50A, 50B. A first projecting feature 50 is disposed on one side of the keeper 24. A second projecting feature 50 is offset from the first projecting feature 50 along the shaft 22 in the longitudinal direction 15b of the shaft. The second projecting feature 50 is disposed on another side of the keeper 24. Each of the first projecting feature 50A and the second projecting feature 50B project outwardly from the shaft 22. The pair of projecting features 50A, 50B are configured to physically limit the longitudinal movement of the shaft 22. These features can reduce the likelihood that the locking portion 20 is unintentionally disconnected from the keeper 24.

In the embodiment of FIGS. 7-9, the body 12 also has a notch 21 in an edge of the body 12. The locking device 20 has a protrusion 27 configured to be received by the notch 21. The protrusion 27 may be referred to as a projecting feature. The protrusion 27 is a wedge-shaped protrusion. The protrusion 27 is configured to be received by the notch 21 to lock the locking device 20 in place when the locking device 20 and handle portion 28 are stowed in the retracted position as shown in FIG. 7.

According to an embodiment in use, when the protrusion 16 is received into the elongate aperture 106 of the connection point 102, rotation of the protrusion 16 leaves an open portion of the aperture 106. The locking device 20 is configured to at least partially fill the open portion to restrict or prevent removal of the protrusion 16 until the lock mechanism 20 is removed from the aperture 106.

The connector 10 can include a body attachment portion 30. The body attachment portion 30 may be for attachment of an elongate member 108 to the connector 10. In other words, the body attachment portion 30 is configured to enable an elongate member 108 to be connected to the connector 10. The elongate member 108 can be a cable or chain or attachment device therefore. The body attachment portion 30 may be a shackle and/or may have an aperture 31 to receive the elongate member 108 or attachment therefore. The body attachment portion 30 can be retained by a retainer 32 such as having a loop or eye 32a attached to or forming part of the body 12.

The body attachment portion 30 can be pivotably attached to the body 12 allowing the body attachment portion 30 to pivot towards the body 12 for stowage and extend outward for use in moving or drawing the container 100 onto the flat-bed tray 40. Such a pivot arrangement can allow for adjustment/variability in the angle of the body attachment portion 30 relative to the body 12 to accommodate varying positions of the elongate member 108. The flat-bed tray may include elongate guides extending along opposite sides of the flat-bed tray.

The protrusion 16 defines a first connection point contacting face 43. The first connection point contacting face 43 is configured to contact an internal surface of the connection point 102. The connector 10 comprises an external engagement portion 44. The external engagement portion 44 is configured to engage an external surface of the connection point 102. In particular, the external engagement portion 44 defines a second connection portion contacting face 45. The second connection portion contacting face 45 is configured to contact the external surface of the connection point 102. In particular, the second connection portion contacting face 45 is configured to contact the external surface of the connection point 102 when the protrusion 16 is received within the connection point 102. An area of the second connection point contacting face 45 is greater than an area of the first connection point contacting face 43.

The connector body 12 and/or the releasable attachment portion 14 can be formed (such as cast or forged) or fabricated of steel. The body 12 and/or releasable attachment portion 14 can each or together be a one-piece casting, forging or fabricated component.

The connector 10 of FIGS. 1A to 3 comprises a tail portion 39. The connector 10 of FIGS. 7 to 9 comprises a tail portion 39. The tail portion 39 of each connector is at an opposite side of the connector 10 to the respective releasable attachment portion 14. The tail portion 39 comprises a planar tail portion face 60. The tail portion face 60 is orthogonal to the longitudinal axis of the body 12 of the connector 10.

Perfectly aligning a flat bed or tray of a road vehicle with a container for loading is difficult. It is therefore not uncommon when aligning a flat bed or tray of a road vehicle with a container for the flat bed or tray to be aligned at a small angle, with respect to the longitudinal axis of the container. This angle can make loading the container onto the truck more difficult as the container 100 may catch on the rear ramp of the vehicle. The tail portion 39 of the connectors 10 described herein provide a surface which may be used to align the container with the road vehicle. Specifically, when reversing, the rear ramp of the road vehicle can be lowered to the ground, and the operator of the vehicle can reverse it towards the container 100. When connectors 10 as described herein are connected to the lower corners of the container 100, the rear ramp will contact one of the tail portions 39 of the two relevant lower connectors 10 first. Further reversing of the truck will apply a force on this tail portion 39, specifically, the tail portion face 60. This force will be transferred through the connector 10, to the container 100, and can move the container 100 to align it with the vehicle. Once the other side of the rear ramp contacts the other connector 10, the container 100 is aligned with the longitudinal axis of the road vehicle.

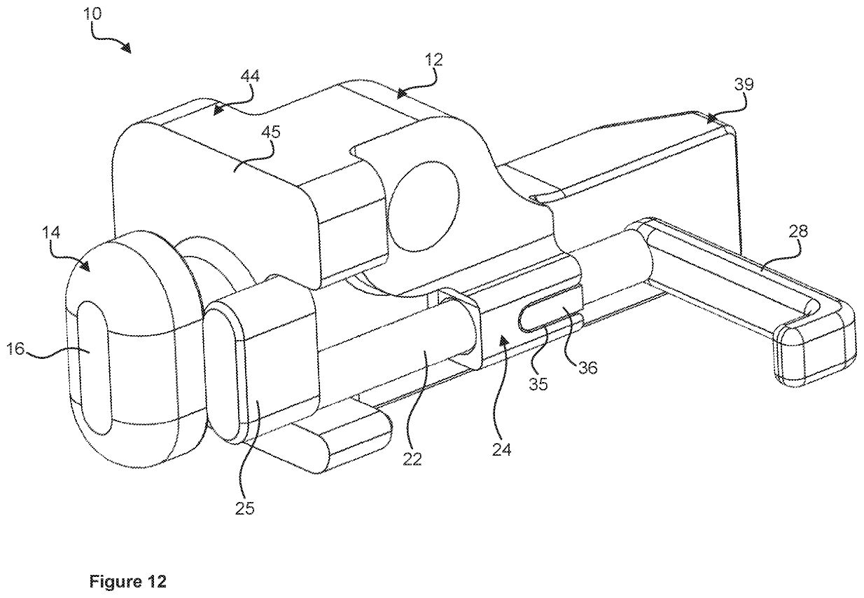

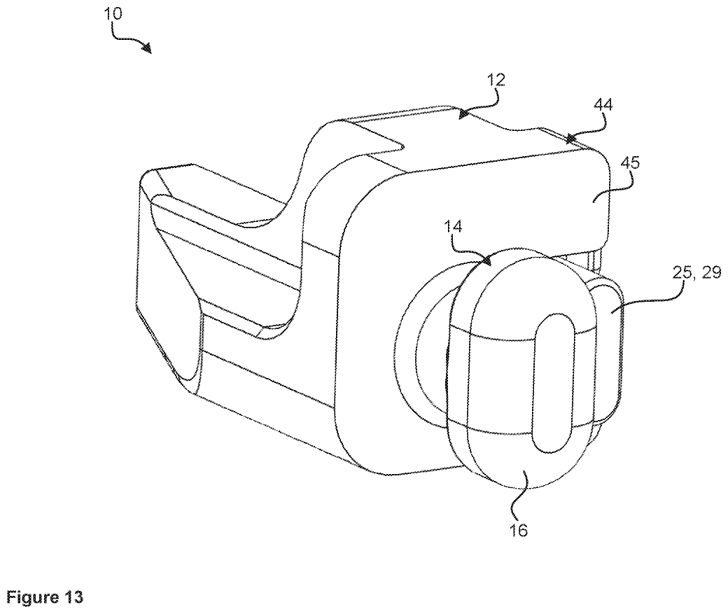

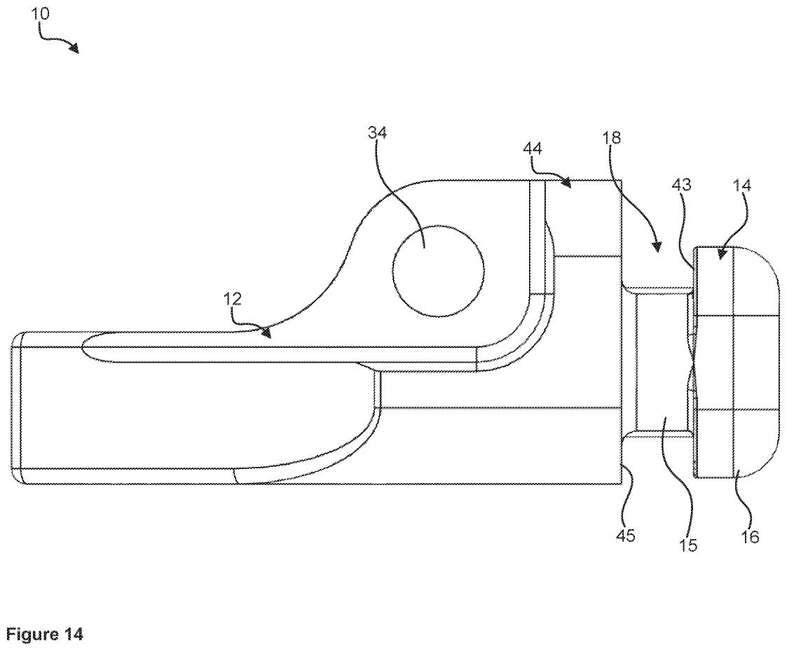

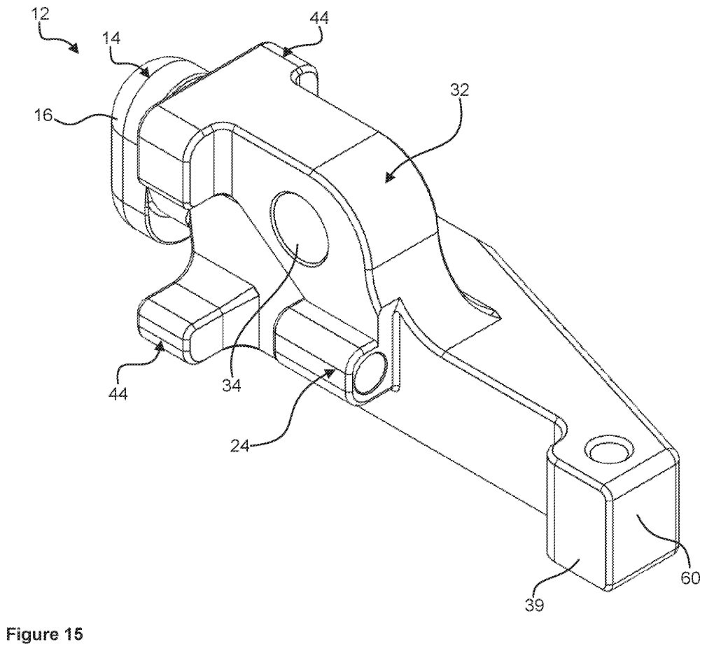

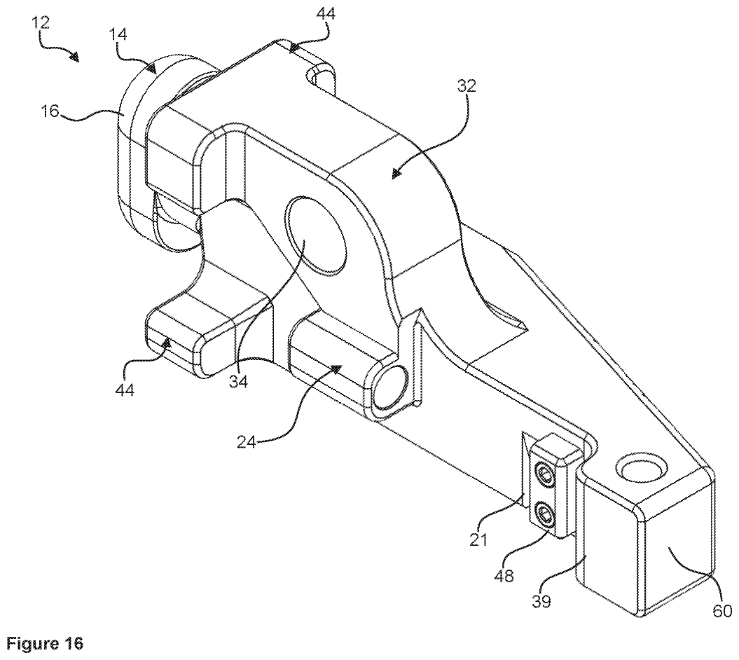

FIGS. 11 to 14 show another embodiment of a connector 10, according to some embodiments. One or more features of the connector 10 of FIGS. 11 to 14 may be similar to, or the same as one or more features of the connector 10 of FIGS. 1A to 3 or FIGS. 7 to 9. It will be appreciated that where a feature of the connector 10 of FIGS. 11 to 14 is the same as, or similar to, a feature of the connector 10 of FIGS. 1A to 3 or FIGS. 7 to 9, a similar or the same reference numeral may be used in FIGS. 11 to 14. One or more features of the connector 10 of FIGS. 11 to 14 may be different from one or more features of the connector 10 of FIGS. 1A to 3 or FIGS. 7 to 9, as described herein. It will be appreciated that the person skilled in the art may combine and/or interchange one or more features of the connector 10 of FIGS. 11 to 14 with one or more features of the connector 10 of FIGS. 1A to 3 or FIGS. 7 to 9, where such a combination or interchange is appropriate. Similarly, the person skilled in the art may combine and/or interchange one or more features of the connector 10 of FIGS. 1A to 3 or FIGS. 7 to 9 with one or more features of the connector 10 of FIGS. 11 to 14, where such a combination or interchange is appropriate.

The connector 10 of FIGS. 11 to 14 comprises a body 12. The connector 10 comprises a releasable attachment portion 14. The releasable attachment portion 14 comprises an elongate portion 15. The elongate portion 15 may be referred to as a shaft. The releasable attachment portion 14 comprises a protrusion 16. The protrusion 16 is disposed at the end of the elongate portion 15.

In the embodiment of FIGS. 11 to 14, the body 12 comprises the releasable attachment portion 14. That is, the releasable attachment portion 14 is part of the body 12. Therefore, the elongate portion 15 and the protrusion 16 are part of the body 12. In other words, the body 12, the elongate portion 15 and the protrusion 16 are integrally formed.

The connector 10 of FIGS. 11 to 14 comprises a channel 18. The channel 18 is provided between the body 12 of the connector 10, and the protrusion 16 of the releasable attachment portion 14. In other words, the body 12 defines the channel 18. The channel 18 is defined between the protrusion 16 and a portion of the body 12.

The connector 10 comprises a locking device 20. The locking device 20 is configured to retain the protrusion 16 in the connection point 102. The locking device 20 comprises a forward end portion 25. The forward end portion 25 may be referred to as a forward end 25. The locking device 20 comprises a shaft portion 22. The forward end portion 25 is configured to connect to the shaft portion 22. The locking device 20 comprises a handle portion 28. The handle portion 28 is configured to connect to the shaft 22.

The connector 10 comprises a locking device retaining portion 24. The locking device retaining portion 24 is configured to facilitate movement of the locking device 20. The locking device retaining portion 24 defines a hole. The locking device 20 extends through the hole.

The locking device retaining portion 24 comprises a groove 35. The groove 35 may be said to be a groove in the body 12, as the locking device retaining portion 24 is integrally formed with the body 12. The locking device 20 comprises an intermediate projection 36. The groove 35 is configured to receive the intermediate projection 36. In particular, the groove 35 is configured to receive the intermediate projection 36 such that relative rotation between the body 12 and the locking device 20 is inhibited when the connector 10 is locked to the connection point 102. The shaft portion 22 comprises the intermediate projection 36.

The connector 10 of FIGS. 11 to 14 comprises a retainer 32. The retainer 32 defines a hole 34 through the body 12. The hole 34 is configured to enable a body attachment portion (not shown) to be connected to the body 12. The body attachment portion may be a shackle and/or may have an aperture to receive an elongate member or attachment therefore.

The protrusion 16 defines a first connection point contacting face 43. The first connection point contacting face 43 is configured to contact an internal surface of the connection point 102. The connector 10 comprises an external engagement portion 44. The external engagement portion 44 is configured to engage an external surface of the connection point 102. In particular, the external engagement portion 44 defines a second connection portion contacting face 45. The second connection portion contacting face 45 is configured to contact the external surface of the connection point 102. In particular, the second connection portion contacting face 45 is configured to contact the external surface of the connection point 102 when the protrusion 16 is received within the connection point 102. An area of the second connection point contacting face 45 is greater than an area of the first connection point contacting face 43.

The external engagement portion 44 at least partially surrounds the forward end portion 25 of the locking device 20. In the illustrated embodiment, the external engagement portion 44 partially surrounds the forward end portion 25 of the locking device 20. The channel 18 is defined between the protrusion 16 and the external engagement portion 44.

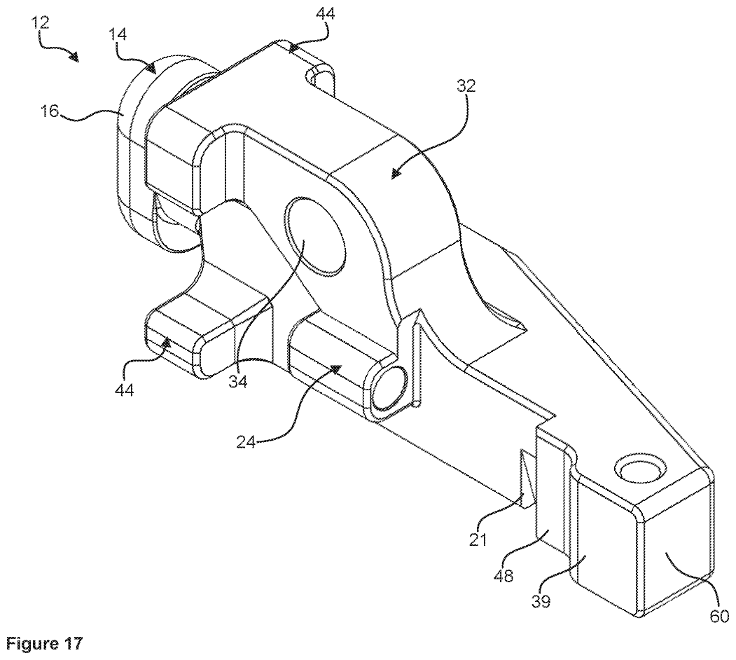

FIG. 15 show another embodiment of a body 12 of a connector 10, according to some embodiments. One or more features of the body 12 of FIG. 15 may be similar to, or the same as one or more features of the body 12 of one of the other connectors described herein. It will be appreciated that where a feature of the body 12 of FIG. 15 is the same as, or similar to, a feature of the body 12 of one of the other connectors described herein, a similar or the same reference numeral may be used in FIG. 15. One or more features of the body 12 of FIG. 15 may be different from one or more features of the body 12 of one of the other connectors described herein. It will be appreciated that the person skilled in the art may combine and/or interchange one or more features of the body 12 of FIG. 15 with one or more features of the body 12 of one of the other connectors described herein, where such a combination or interchange is appropriate. Similarly, the person skilled in the art may combine and/or interchange one or more features of the body 12 of one of the other connectors described herein with one or more features of the body 12 of FIG. 15, where such a combination or interchange is appropriate.

The body 12 of FIG. 15 does not comprise the groove 35 in the locking device retaining portion 24. The body 12 of FIG. 15 comprises a thickened tail portion 39. In some embodiments, the tail portion 39 defines a corner. The tail portion 39 may be configured to inhibit axial movement of the locking device 20, when installed. The tail portion 39 is also configured to enable a road vehicle to apply a force to the connector 10, when installed on a container 100, to move the container. The tail portion 39 comprises a tail portion face 60.

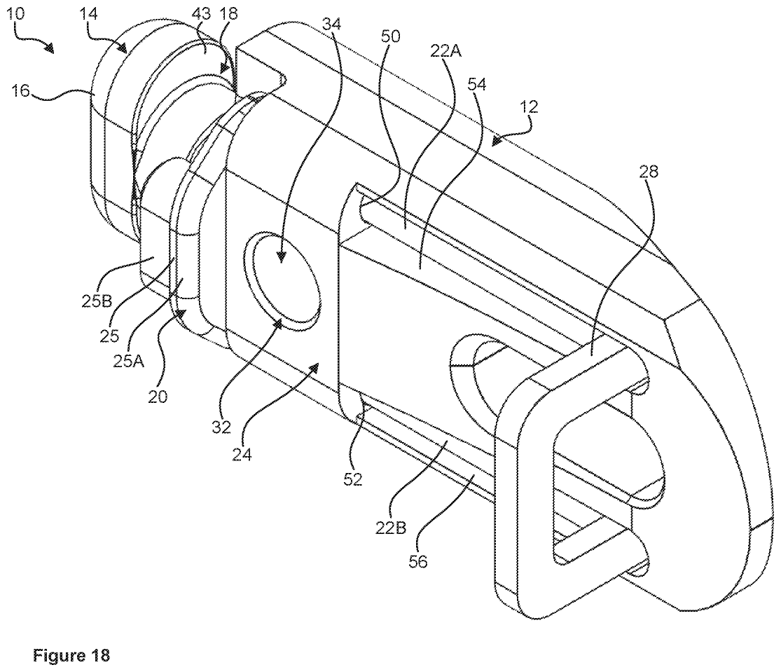

FIG. 16 shows another embodiment of a body 12 of a connector 10, according to some embodiments. One or more features of the body 12 of FIG. 16 may be similar to, or the same as one or more features of one of the other bodies 12 described herein. It will be appreciated that where a feature of the body 12 of FIG. 16 is the same as, or similar to, a feature of one of the other bodies 12 described herein, a similar or the same reference numeral may be used in FIG. 16. One or more features of the body 12 of FIG. 16 may be different from one or more features of one of the other bodies 12 described herein. It will be appreciated that the person skilled in the art may combine and/or interchange one or more features of the body 12 of FIG. 16 with one or more features of one of the other bodies 12 described herein, where such a combination or interchange is appropriate. Similarly, the person skilled in the art may combine and/or interchange one or more features of one of the other bodies 12 described herein with one or more features of the body 12 of FIG. 16, where such a combination or interchange is appropriate.

The body 12 of FIG. 16 comprises an axial stop 48. The axial stop 48 is disposed towards the tail portion 39 of the body 12. That is, the axial stop 48 is closer to the tail portion 39 than the protrusion 16. The axial stop 48 is configured to inhibit movement of the locking device 20 in an axial direction. The axial stop 40 is removably connected to the body 12. In the illustrated example, the axial stop 48 includes a number of threaded holes. The body 12 also comprises threaded holes. Thus, the axial stop 48 may be connected to the rest of the body 12 using screws. In some embodiments, the axial stop 48 may be integrally formed with the rest of the body 12.

The body 12 of FIG. 16 also comprises a notch 21. The locking device 20 may comprise a protrusion that is configured to fit within the notch 21. Alternatively, the handle portion 28 of the locking device 20 may be configured to be received within the notch 21. When a part of the locking device 20 is received within the notch 21, axial movement of the locking device 20 is inhibited. In this case, the axial movement is inhibited when the locking device 20 is in an unlocked configuration. The notch 21 is in the form of a recess in the body 12. The notch 21 is adjacent to the axial stop 48. That is, the notch 21 is closer to the tail portion 39 of the body 12 than the protrusion 16.

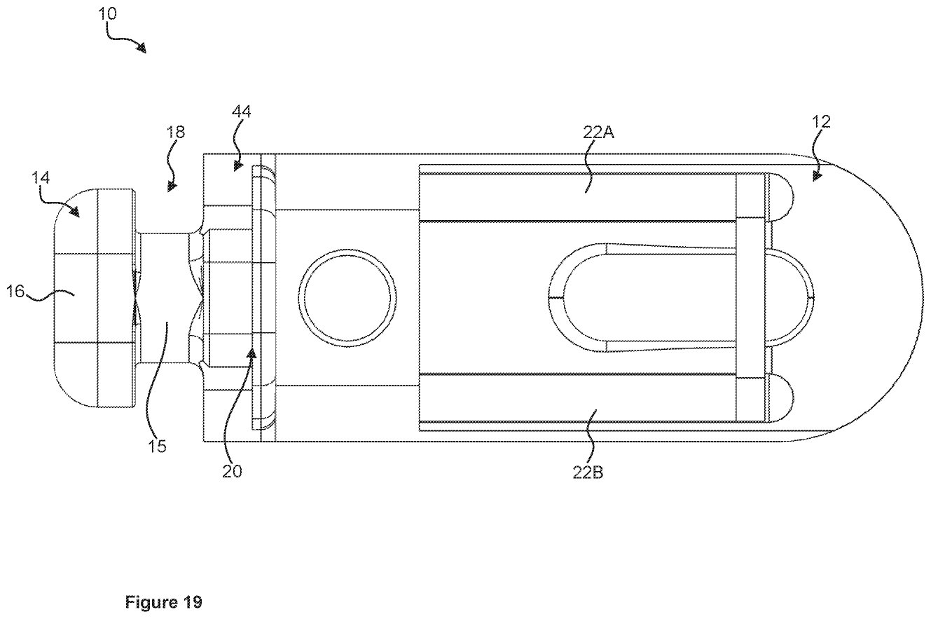

FIG. 17 shows another embodiment of a body 12 of a connector 10, according to some embodiments. One or more features of the body 12 of FIG. 17 may be similar to, or the same as one or more features of one of the other bodies 12 described herein. It will be appreciated that where a feature of the body 12 of FIG. 17 is the same as, or similar to, a feature of one of the other bodies 12 described herein, a similar or the same reference numeral may be used in FIG. 17. One or more features of the body 12 of FIG. 17 may be different from one or more features of one of the other bodies 12 described herein. It will be appreciated that the person skilled in the art may combine and/or interchange one or more features of the body 12 of FIG. 17 with one or more features of one of the other bodies 12 described herein, where such a combination or interchange is appropriate. Similarly, the person skilled in the art may combine and/or interchange one or more features of one of the other bodies 12 described herein with one or more features of the body 12 of FIG. 17, where such a combination or interchange is appropriate.

The body 12 of FIG. 17 comprises an axial stop 48. In this case, the axial stop 48 is integrally formed with the rest of the body 12. That is, the axial stop 48 is formed contemporaneously with the rest of the body 12, for example, in a moulding or machining manufacturing process.

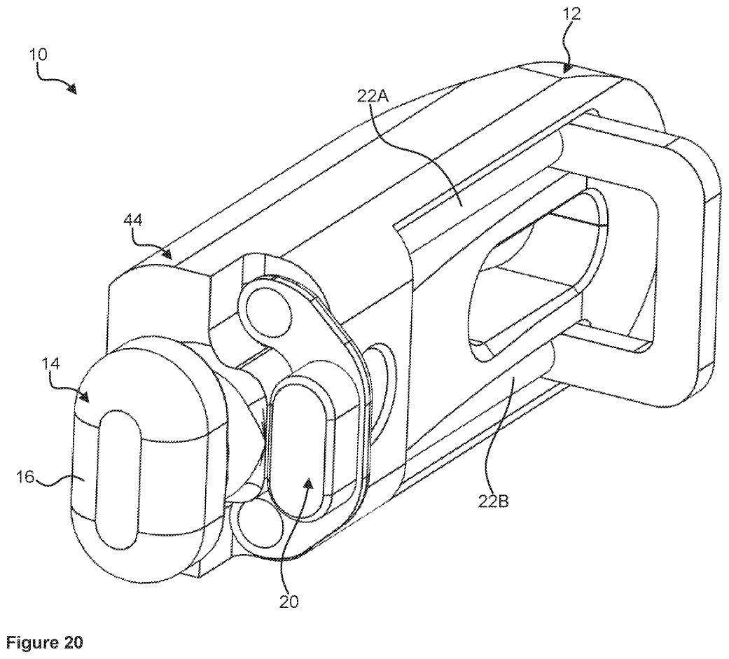

FIGS. 18 to 20 show another embodiment of a connector 10, according to some embodiments. One or more features of the connector 10 of FIGS. 18 to 20 may be similar to, or the same as one or more features of one of the other connectors 10 described herein. It will be appreciated that where a feature of the connector 10 of FIGS. 18 to 20 is the same as, or similar to, a feature of one of the other connectors 10 described herein, a similar or the same reference numeral may be used in FIGS. 18 to 20. One or more features of the connector 10 of FIGS. 18 to 20 may be different from one or more features of one of the other connectors 10 described herein. It will be appreciated that the person skilled in the art may combine and/or interchange one or more features of the connector 10 of FIGS. 18 to 20 with one or more features of one of the other connectors 10 described herein, where such a combination or interchange is appropriate. Similarly, the person skilled in the art may combine and/or interchange one or more features of one of the other connectors 10 described herein with one or more features of the connector 10 of FIGS. 18 to 20, where such a combination or interchange is appropriate.

The connector 10 of FIGS. 18 to 20 comprises a body 12. The connector 10 comprises a releasable attachment portion 14. The releasable attachment portion 14 comprises an elongate portion 15. The elongate portion 15 may be referred to as a shaft. The releasable attachment portion 14 comprises a protrusion 16. The protrusion 16 is disposed at the end of the elongate portion 15.

In the embodiment of FIGS. 18 to 20, the body 12 comprises the releasable attachment portion 14. That is, the releasable attachment portion 14 is part of the body 12. Therefore, the elongate portion 15 and the protrusion 16 are part of the body 12. In other words, the body 12, the elongate portion 15 and the protrusion 16 are integrally formed.

The connector 10 of FIGS. 18 to 20 comprises a channel 18. The channel 18 is provided between the body 12 of the connector 10, and the protrusion 16 of the releasable attachment portion 14. In other words, the body 12 defines the channel 18. The channel 18 is defined between the protrusion 16 and a portion of the body 12.

The connector 10 comprises a locking device 20. The locking device 20 is configured to retain the protrusion 16 in the connection point 102. The locking device 20 comprises a forward end portion 25. The forward end portion 25 may be referred to as a forward end 25. The forward end portion 25 comprises a base 25A. The forward end portion 25A comprises a forward end projection 25B. The forward end projection 25B projects outwards from the base 25A.

The locking device 20 comprises a first shaft portion 22A. The first shaft portion 22A may be referred to as a first shaft. The first shaft portion 22A is connected to the forward end portion 25. The first shaft portion 22A extends away from the forward end portion 25. The locking device 20 comprises a second shaft portion 22B. The second shaft portion 22B may be referred to as a second shaft. The second shaft portion 22B is connected to the forward end portion 25. The second shaft portion 22B extends away from the forward end portion 25. The forward end portion 25 bridges the first shaft portion 22A and the second shaft portion 22B. The first shaft portion 22A and the second shaft portion 22B are parallel.

The forward end projection 25B projects outwards from the base 25A, away from the first shaft portion 22A and/or the second shaft portion 22B. The first shaft portion 22A extends from its point of connection to the forward end portion 25, away from the forward end projection 25B. The second shaft portion 22B extends from its point of connection to the forward end portion 25, away from the forward end projection 25B.

The connector 10 comprises a locking device retaining portion 24. The locking device retaining portion 24 is configured to facilitate movement of the locking device 20. The locking device retaining portion 24 comprises a first hole 50. The first hole 50 is a hole in the body 12. The first shaft portion 22A extends through the first hole 50. The locking device retaining portion 24 comprises a second hole 52. The second hole 52 is a hole in the body 12. The second shaft portion 22B extends through the second hole 52. The elongate portion 15 of the connector 10, the first hole 50, the second hole 52, the first shaft portion 22A and the second shaft portion 22B are all parallel.

The body 12 comprises a first groove 54. In particular, the locking device retaining portion 24 comprises the first groove 54. The first groove 54 is configured to receive the first shaft portion 22A. The body 12 comprises a second groove 56. In particular, the locking device retaining portion 24 comprises the second groove 56. The second groove 56 is configured to receive the second shaft portion 22B.

The locking device 20 comprises a handle portion 28. The handle portion 28 is U-shaped. The handle portion 28 extends between the first shaft portion 22A and the second shaft portion 22B. The handle portion 28 is disposed at an opposite end of each of the first shaft portion 22A and the second shaft portion 22B as the forward end portion 25.

The connector 10 of FIGS. 18 to 20 comprises a retainer 32. The retainer 32 defines a hole 34 through the body 12. The hole 34 is configured to enable a body attachment portion (not shown) to be connected to the body 12. The body attachment portion may be a shackle and/or may have an aperture to receive an elongate member for attachment therefore. The retainer 32 is integrally formed with the body 12. The hole 34 extends between the first shaft portion 22A and the second shaft portion 22B. In other words, the first shaft portion 22A is on an opposite side of the hole 34 as the second shaft portion 22B.

The protrusion 16 defines a first connection point contacting face 43. The first connection point contacting face 43 is configured to contact an internal surface of the connection point 102. The connector 10 comprises an external engagement portion 44. The external engagement portion 44 is configured to engage an external surface of the connection point 102. In particular, the external engagement portion 44 defines a second connection portion contacting face 45. The second connection portion contacting face 45 is configured to contact the external surface of the connection point 102. In particular, the second connection portion contacting face 45 is configured to contact the external surface of the connection point 102 when the protrusion 16 is received within the connection point 102. An area of the second connection point contacting face 45 is greater than an area of the first connection point contacting face 43. The channel 18 is defined between the protrusion 16 and the external engagement portion 44.

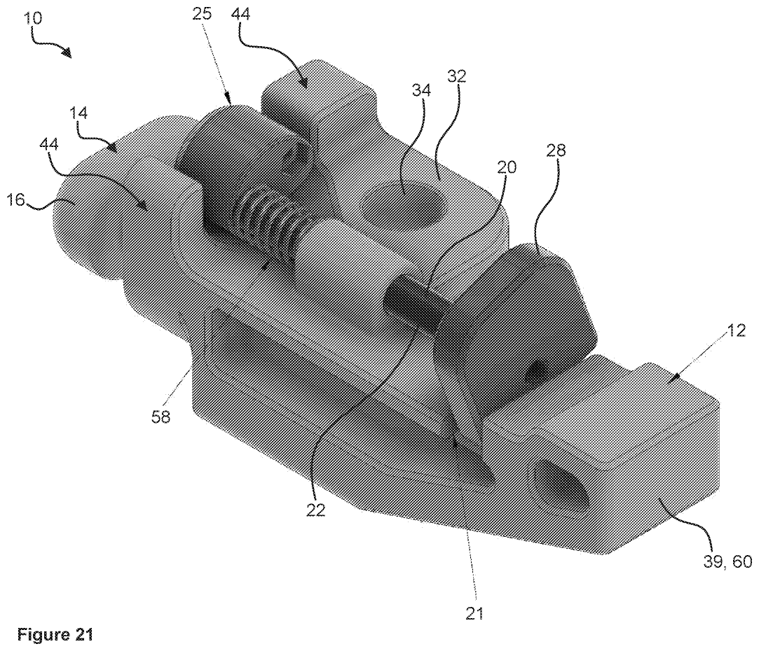

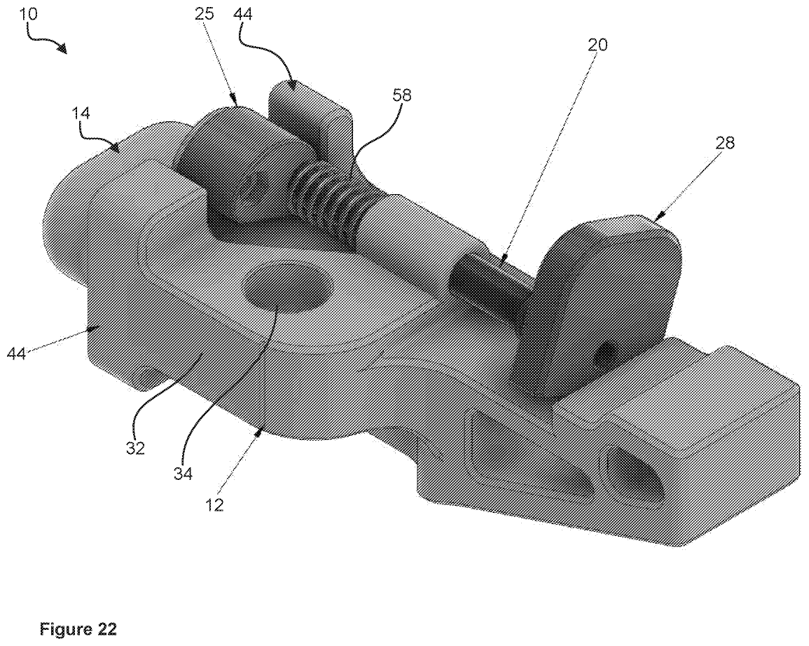

FIGS. 21 and 22 show another embodiment of a connector 10, according to some embodiments. One or more features of the connector 10 of FIGS. 21 and 22 may be similar to, or the same as one or more features of one of the other connectors 10 described herein. It will be appreciated that where a feature of the connector 10 of FIGS. 21 and 22 is the same as, or similar to, a feature of one of the other connectors 10 described herein, a similar or the same reference numeral may be used in FIGS. 21 and 22. One or more features of the connector 10 of FIGS. 21 and 22 may be different from one or more features of one of the other connectors 10 described herein. It will be appreciated that the person skilled in the art may combine and/or interchange one or more features of the connector 10 of FIGS. 21 and 22 with one or more features of one of the other connectors 10 described herein, where such a combination or interchange is appropriate. Similarly, the person skilled in the art may combine and/or interchange one or more features of one of the other connectors 10 described herein with one or more features of the connector 10 of FIGS. 21 and 22, where such a combination or interchange is appropriate.

The connector 10 of FIGS. 21 and 22 comprises a notch 21. The notch 21 may be as described herein with reference to one or more other connectors. Specifically, the notch 21 is a notch 21 in the body 12. The notch 21 is configured to receive at least part of the handle portion 28 of the locking device 20. The connector 10 is configured such that rotation of the locking device 20, about the longitudinal axis of the shaft portion 22, can result in the handle portion 28 rotating into and out of the notch 21. The notch 21 may therefore inhibit axial movement of the locking device 20 when the handle portion 28 is received within the notch 21. Axial movement of the locking device 20 is enabled when the handle portion 28 is not received within the notch 21.

The connector 10 of FIGS. 21 and 22 comprises a biasing member 58. The biasing member 58 is disposed between the forward end portion 25 of the locking member 20 and part of the locking device retaining portion 24. The biasing member 58 contacts the forward end portion 25 of the locking member 20. The biasing member 58 contacts the locking device retaining portion 24. In other words, the biasing member 58 contacts the body 12. The biasing member 58 is configured to bias the locking device 20 in an axial direction. The biasing member 58 is configured to bias the locking device 20 in a locked position. In other words, the biasing member 58 is configured to bias the forward end portion 25 of the locking member 20 towards the protrusion 16. The biasing member 58 may also apply a rotary bias on the locking member 20. Specifically, the locking member 58 may apply a clockwise or a counter clockwise bias on the locking member 20.

As shown in FIGS. 4, 5 and 10, the apparatus 11 comprises a first connector 10a and a second connector 10b. The first connector 10a and/or the second connector 10b may be in the form of one of the connectors 10 described herein. The first connector 10a and the second connector 10b may be engaged with a respective lower corner connection point 102a, 102b respectively of the container 100. An elongate member 108 (such as a cable or chain, or a cable and chain combination), when in use, connects the first connector 10a and the second connector 10b. The apparatus 11 may be said to comprise the elongate member 108. The elongate member 108 is flexible and attachable directly or indirectly to a winch for drawing the container 100 onto the flat-bed tray 40 of a vehicle by force applied to the elongate member 108 and the connectors 10a, 10b attached to the spaced connection points 102a, 102b respectively of the container 100.

In FIG. 10, the elongate member 108 is shown to extend through the aperture 31 of the body attachment portion 30 of each connector 10a, 10b. It will be appreciated that in some embodiments, the elongate member may extend between a first end that comprises a first hook and a second end that comprises a second hook. The first hook may be configured to connect to the first connector 10a at the body attachment portion 30 of the first connector. The second hook may be configured to connect to the second connector 10b at the body attachment portion 30 of the second connector. In this way, the elongate member 108 may be pulled to impart a force on each connector 10a, 10b, thereby moving the container 100 to which they are connected.

In some embodiments, the hooks and the attachment portions 30 may be a common colour. This can be useful in providing an indication to an operator as to which components are to be connected. The rest of the connectors 10 may be another colour, different to the colour of the hooks and the attachment portions 30. Similarly, the rest of the elongate member 108 (i.e. the elongate member 108, excluding the hooks) may be a different colour to the colour of the hooks and the attachment portions 30.

The first connector 10a and the second connector 10b are preferably handed, that is, right handed or left handed, such that the first connector 10a includes part of the releasable attachment portion 14 that rotates in a first direction to connect the connector 10 to the container 100, and the second connector 10b includes part of a further said releasable connection portion 14 that rotates in a second direction opposite to the first direction. In an embodiment, all of the first connector 10a and/or all of the second connector 10b are rotated for connection to the container 100.

Alternatively, in another embodiment, part of the first connector 10a and/or part of the second connector 10b are rotated for connection to the container 100.

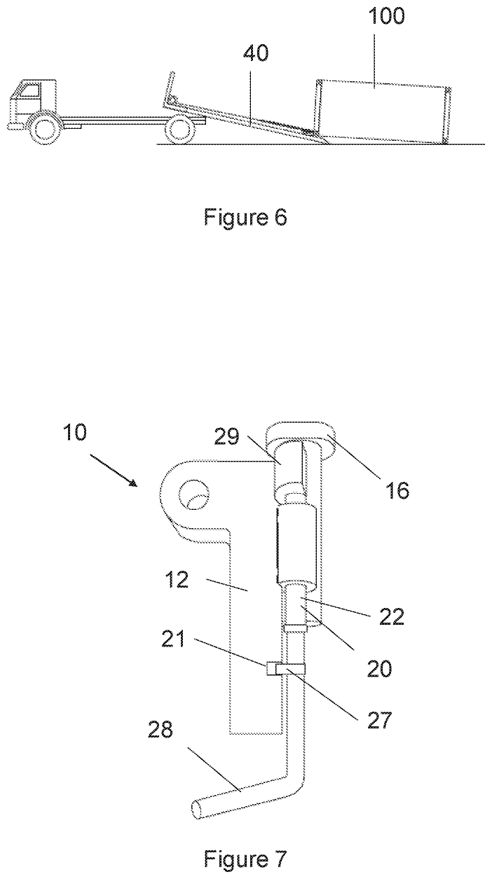

The method of loading the container 100 onto the flat-bed or tray 40 of a truck includes initially attaching a respective connector 10a, 10b to each of the first and second connection points 102a, 102b at respective lower corners 104a, 104b of an end of a shipping container 100. The flexible elongate member 108, such as a chain or cable, is then connected between the first and second connectors 10a, 10b, as shown in FIGS. 4 and 5. A winch cable is then connected between a winch of the vehicle and the flexible elongate member 108, so that inclining the flat-bed or tray 40 at an angle such that a lower edge of the flat-bed or tray 40 engages under the first and second connectors 10a, 10b and/or a lower end edge of the container 100, as shown in FIG. 6. This then draws the container 100 onto the flat-bed or tray 40 by use of the winch.

Inclination of the flat-bed or tray 40 can be reduced towards horizontal when the container 100 is at least partly loaded onto the flat-bed or tray 40. The method further includes that the first and/or second connectors 10a, 10b can be rotated for connection to the container 100.

In addition, the second connector 10b is rotated in a different direction to the direction of the rotation of the first connector 10a for releasable engagement with the container 100. Furthermore, the method includes that a locking device 20 has a portion 16 configured to insert into the respective connection device 102 (the connection device 102 not shown in FIGS. 7, 8 and 9). This prevents or minimises reverse rotation of the connector 10 until the respective locking device is released.

The first and second connectors 10a, 10b and the flexible elongate member (e.g. chain or cable) 108 can be provided as a kit of components.

It will be appreciated that the connectors 10a, 10b can be separated from each other i.e. unattached via the elongate member 108. The elongate member 108 can also remain attached to at least one of the connectors 10a, 10b. Each of the connectors 10a, 10b can be readily handled into and out of stowage on the vehicle by a single person.

It will be appreciated that one or more forms of the present invention advantageously provides for efficient loading of shipping containers onto vehicle tilt trays/beds.

It will be appreciated that one or more forms of the present invention may be used with shipping containers that have been in less than ideal ground conditions, such as soft ground over long periods.

It will be appreciated that one or more forms of the present invention enables versatility of scope across a range of shipping containers in a variety of sizes. The elongate member, such as the chain or cable, is multi-functional to assist with lifting the shipping container from soiled conditions.

It will be appreciated that the connector is a compact apparatus, that is easy to use and store via a truck dog/storage box.

The connector allows a process for onboarding of shipping containers to reduce the risk of safety concerns, for example: reduce exposure of walking on the tilt tray whilst it is tilted/tilting (hazard reduction).

In the claims which follow and in the preceding description of the invention, except where the context requires otherwise due to express language or necessary implication, the word “comprise” or variations such as “comprises” or “comprising” is used in an inclusive sense, i.e. to specify the presence of the stated features but not to preclude the presence or addition of further features in various embodiments of the invention.

It is to be understood that, if any prior art publication is referred to herein, such reference does not constitute an admission that the publication forms a part of the common general knowledge in the art, in Australia or any other country.

It will be understood to persons skilled in the art of the invention that many modifications may be made without departing from the spirit and scope of the invention.

| Element Number | Element |
|---|---|
| 10, 10a, 10b | Apparatus/connector/first connector, second connector |
| 12 | Body |
| 14 | Releasable attachment portion |
| 15 | Shaft of releasable attachment portion |
| 15a | Longitudinal axis of shaft of releasable attachment |
| | portion |
| 15b | Longitudinal direction of shaft |
| 16 | Latch/Protrusion/Portion/Attaching portion/Connection |
| | point engaging portion |
| 16a | First outer dimension - protrusion |
| 16b | First direction - protrusion |
| 16c | Second outer dimension - protrusion |
| 16d | Second direction - protrusion |
| 16e | Portion of protrusion |
| 17a | First shaft end |
| 17b | Second shaft end |
| 17c | Shaft outer dimension |
| 17d | Radial direction of the shaft |
| 18 | Channel |
| 19 | Central portion of the protrusion |
| 20 | Locking device |
| 21 | Notch (FIGS. 7-9) |
| 22 | Shaft portion |
| 23 | Slide bolt or slide lock member |
| 24 | Locking device retaining portion |
| 25 | Forward end portion |
| 26 | Trailing end |
| 27 | Protrusion on locking device to match to notch in |
| | FIGS. 7-9 |
| 28 | Handle portion |
| 29 | Lobe |
| 30 | Body attachment portion |
| 31 | Aperture |
| 32, 32a | Retainer |
| 33 | Stop for locking device 20 (FIGS. 8-9) |
| 34 | Hole of retainer 32 |
| 35 | Groove in locking device retaining portion 24 |
| 36 | Intermediate projection |
| 37 | First connection point contacting face |
| 39 | Tail portion |
| 40 | Flat-bed tray of vehicle |
| 42 | Wall portion of connection point 102a, 102b (FIG. 3) |
| 43 | First connection point contacting face |
| 44 | External engagement portion |
| 45 | Second connection portion contacting face |
| 48 | Axial stop |
| 50 | First hole of locking device retaining portion 24 |
| 52 | Second hole of locking device retaining portion 24 |
| 54 | First groove |
| 56 | Second groove |
| 58 | Biasing member |
| 60 | Tail portion face |
| 100 | Container |
| 102 | Connection point, |
| 102a | First connection point of container 100 (connection |
| | device) |
| 102b | Second connection point of container 100 (connection |
| | device) |
| 102c | Hollow internal volume of connection point 102 |
| 102d | Inner surface of the connection point 102 |
| 104a, 104b | Lower corners |
| 106 | Aperture (elongate aperture) |
| 106a | First aperture dimension |
| 106b | First aperture measurement direction |
| 106c | Second aperture dimension |
| 106d | Second aperture measurement direction |
| 108 | Elongate member (cable or chain) |

1.-61. (canceled)

62. A connector for releasable securement to an opening in a corner fitting of a shipping container, the connector comprising:
a body with an attachment portion extending therefrom, the attachment portion configured to be received in the opening of the corner fitting; and
a locking device actuable between and locking position and a retracted position, the locking device having a portion configured for insertion into the opening alongside the attachment portion,
wherein the body is movable between a first condition in which the attachment portion can be inserted into the opening and a second condition in which the attachment portion cannot be removed through the opening, and
wherein, when in the locking position, the locking device is configured to prevent removal of the attachment portion from the opening once the locking device has been received in the opening.

63. The connector according to claim 62, wherein the attachment portion has a protrusion for insertion into the opening, the protrusion being shaped such that it is longer in a major direction than in a minor direction.

64. The connector according to claim 62, wherein the locking device is actuable via sliding.

65. The connector of claim 62, wherein the locking device includes a tab, flange, cam or lobe that is configured to be inserted into the opening of the corner fitting.

66. The connector of claim 62, wherein the locking device comprises a biasing member that is configured to bias the locking device in a locked position.

67. The connector of claim 66, further comprising a notch formed in the body for retaining the locking device in a retracted position.

68. The connector of claim 62, wherein the body of the connector comprises a locking device retaining portion which defines a hole through which the locking device extends.

69. The connector according to claim 62, further including a tab extending from the body for receipt of an elongate member used for coupling like connectors disposed at opposite corners of the container.

70. The connector according to claim 62, wherein an underside of the body is angled at an end remote from the corner fitting for engagement with a tilt tray to lift the container during loading.

71. The connector of claim 62, wherein one or more of the body and the releasable attachment portion are made of steel.

72. The connector of claim 71, wherein the body is made by one-piece casting, forging or fabrication and/or the releasable attachment portion is made by one-piece casting, forging or fabrication.

73. An apparatus including:
first and second connectors, each according to claim 1; and
a flexible elongate member configured to connect the first and second connectors.

74. The apparatus of claim 73, wherein the flexible elongate member includes a cable or chain, or a cable and chain combination.

75. The apparatus of claim 73, wherein the first and second connectors are each handed, such that the attachment portion of the first connector rotates in a first direction to connect the connector to the container, and the attachment portion of the second connector rotates in a second direction to connect the second connector to the container.

76. A method of loading a container onto a truck flat-bed or tray, including the steps of:
providing an apparatus according to claim 73,
attaching the first connector to a first connection point at a respective lower corner of an end of a shipping container;
attaching the second connector to a second connection point at another lower corner of the end of the shipping container;
providing a flexible elongate member to couple the connectors;
providing a winch cable connected between a winch of the vehicle and the flexible elongate member;
inclining the flat-bed or tray at an angle such that a lower edge of the flat-bed or tray engages under the connectors and/or a lower end edge of the container; and
drawing the container onto the flat-bed or tray by use of the winch.

77. The method of claim 76, wherein the inclination of the flat-bed or tray is reduced towards horizontal when the container is at least partly loaded onto the flat-bed or tray.

78. The method of claim 77, wherein the connectors are rotated for connection to the container.

79. The method of claim 78, wherein the second connector is rotated in a different direction to the direction of the rotation of the first connector for releasable engagement with the container.

80. The method of claim 76, further including the step of actuating the locking device to secure the attachment portion in the opening.
